(19) United States
(12) Patent Application Publication
(10) Pub. No.: US 2003/0110128 A1
(43) Pub. Date: Jun. 12, 2003

(54) Method and system for importing invoice data into accounting and payment programs

(75) Inventors: Thomas J. Foth, Trumbull, CT (US); Jeffrey D. Pierce, Sandy Hook, CT (US); Howard M. Citron, South Salem, NY (US); G. Jonathan Wolfman, Southbury, CT (US); Brian M. Romansky, Monroe, CT (US)

Correspondence Address: PITNEY BOWES INC., 35 WATERVIEW DRIVE, P.O. BOX 3000, MSC 26-22, SHELTON, CT, 06484-8000, US

(73) Assignee: Pitney Bowes Incorporated, Stamford, CT

(21) Appl. No.: 10/011,086

(22) Filed: Dec. 7, 2001

(51) Int. Cl. G06F 17/60

(52) U.S. Cl. 705/40

(57) ABSTRACT

A system and method for bridging existing paper-based invoicing methods to electronic methods that is simple to use and cost effective is disclosed. A billing party generates a transaction identification number in the process of preparing an invoice and sends the transaction identification number to the consumer via a physical mail piece or e-mail. The invoice data is stored in a standard format in a secure server along with the transaction identification number. The consumer, upon receipt of the physical mail piece, inputs the transaction identification number to a computer, such as, for example, by scanning, accesses the secure server and sends the transaction identification number to retrieve the invoice data. The invoice data is then automatically entered into the consumer's software systems.

### FIELD OF THE INVENTION

The invention disclosed herein relates generally to electronic invoicing, and more particularly to a method and system for electronically retrieving an invoice and automatically importing data from the invoice into one or more software systems.

### BACKGROUND OF THE INVENTION

In many business to business and business to consumer transactions for goods and/or services, payment is not made at the point of purchase but instead made in response to a bill sent at the end of a billing cycle by the vendor, such as, for example, a monthly bill. Billing parties commonly print and mail paper bills to consumers, and consumers respond by writing and mailing payment checks back to the billing parties. For example, consumers typically write checks each month to pay bills for utilities, credit card charges, and the like. For convenience, the term “consumer” as used herein represents both a typical person that consumes goods and services as well as a business that consumes goods and services. Additionally, a “billing party” or “biller” or “vendor” as used herein represents any party that originates billing statements for goods and services rendered to a consumer. Examples of billers include, without limitation, utilities, merchants, and intermediate billing services such as banks or credit cards.

When a consumer receives a paper bill, entries are typically made into accounting and/or payment software systems to record the information included in the paper bill. For example, accounts payable clerks for businesses typically enter the information from the paper bill into an accounting software system. Additionally, there is a growing popularity and use of personal finance management (PFM) computer software to assist consumers in managing their finances. Examples of such PFM software include “Money” from Microsoft Corporation and “Quicken” from Intuit, Inc. PFM users receive the paper bills, enter the information from the paper bills into their computers, and manage payment of the bills electronically. Additionally, consumers may also use an on-line payment system to pay bills. Typically, the consumer is required to access a server, view the current charges, and provide authorization for payment of the bill.

There are problems, however, with the manual entry of invoices into a software system and the use of on-line payment systems. With respect to manual entry, the data from the paper bill must be accurately entered into the accounting software. A small mistake in entering the data could possibly lead to a major financial miscalculation. Additionally, it can be quite time consuming to enter the data from the paper bill into a software system, especially for consumers having large volumes of such bills. The amount of entry time is further increased if more than one software program is utilized, such as for example an accounting software system and a payment software system. With respect to on-line payment systems, these systems require the consumer to proactively communicate with the server to retrieve the bill. Many consumers still prefer to receive a paper bill to trigger payment; without the paper-bill trigger, it is possible that some consumers will forget to pay the bill on time, thereby incurring unnecessary finance charges.

To alleviate some of the above problems, many billers have begun to use an Electronic Data Interchange (EDI) invoice system. These electronic invoices contain the same information as do analogous paper invoices, but the information is electronically transmitted via a network from the biller's computer system to a remote computer in a standardized format. However, the integration of such EDI invoices can be costly to the billers and consumers. Furthermore, some consumers may additionally wish to still receive a paper copy of the invoice for archiving.

Thus, there exists a need for a system and method for bridging existing paper-based invoicing methods to electronic methods that is simple to use and cost effective. In addition, there exists a need for a system and method to improve a consumer's experience with paying bills, making the paying of bills both easy and efficient, while also providing advance information to the billers regarding consumer action towards paying the bill.

### SUMMARY OF THE INVENTION

The present invention alleviates the problems associated with the prior art and provides a system and method for bridging existing paper-based invoicing methods to electronic methods that is simple to use and cost effective, enriches the experience for the consumer, and provides advance information to a biller concerning payment of the bill by the consumer.

In accordance with the present invention, the billing party generates an associated unique transaction identifier, such as, for example, a randomly generated number or an invoice number, in the process of preparing an invoice and sends the unique transaction identifier to the consumer via a physical mail piece or e-mail. The invoice data is stored in a standard format in a secure server in a location associated with at least the unique transaction identifier. The consumer, upon receipt of the physical mail piece inputs the unique transaction identifier to a computer, such as, for example, by scanning, accesses the secure server and sends the unique transaction identifier to retrieve the invoice data. The invoice data is then automatically entered into the consumer's software systems.

### DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 illustrates in block diagram form a system for importing invoice data according to the present invention;

FIG. 2 illustrates in flow chart form the process of importing invoice data according to the present invention; and

FIGS. 3A-3D illustrate database tables utilized by the system for importing invoice data according to the present invention.

### DETAILED DESCRIPTION OF THE PRESENT INVENTION

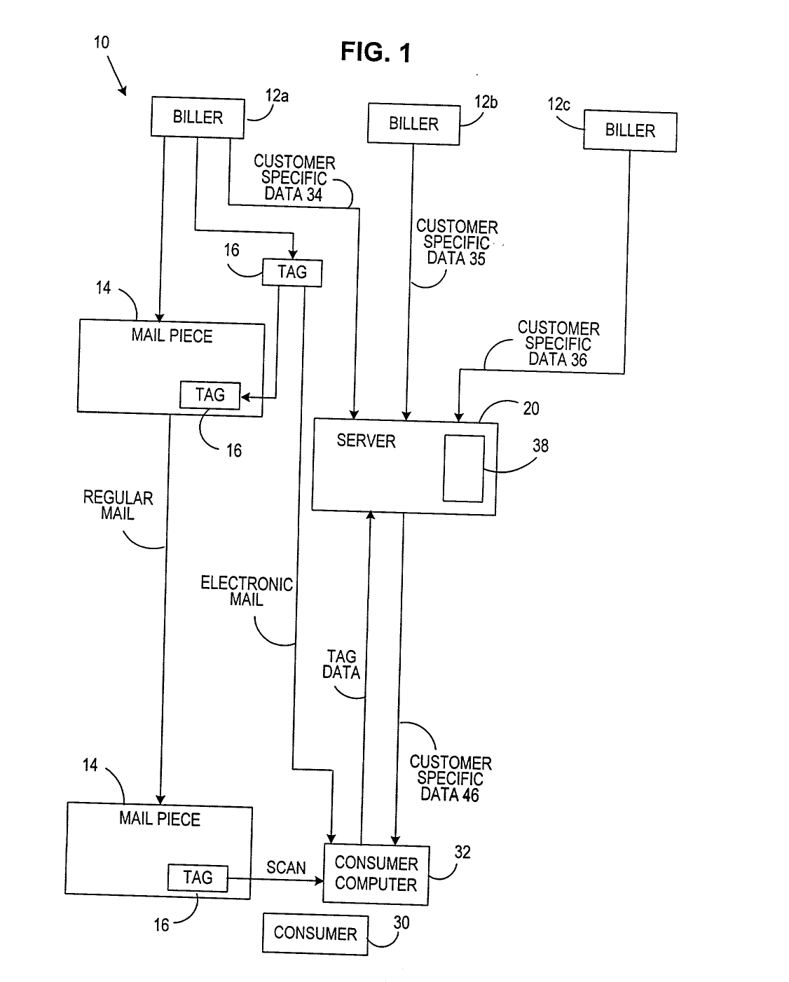

In describing the present invention, reference is made to the drawings, wherein there is seen in FIG. 1 a system 10 for importing invoice data according to the present invention. System 10 includes one or more vendors (billers) 12a, 12b, 12c, such as, for example, a utility or credit card company, and a plurality of consumers 30 (only one illustrated for clarity). System 10 further includes a server 20, preferably developed as a web site on the World Wide Web (WWW), and accessed utilizing Internet technology by consumer 30 via a personal computer 32.

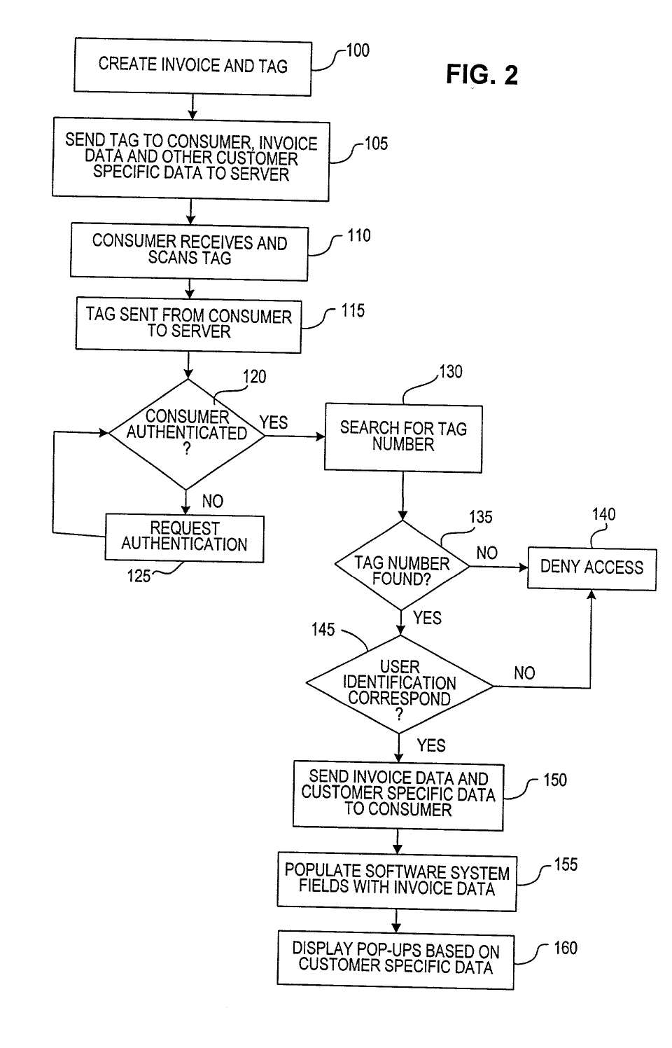

The operation of the system 10 of FIG. 1 will be described with reference to the flow chart of FIG. 2, which illustrates the process of importing invoice data according to the present invention. For clarity, the operation of the system 10 according to the present invention will be described with respect only to biller 12a. It should be understood that system 10 can include any number of billers that will operate in the same manner.

In step 100, biller 12a creates an invoice for a consumer 30. During the process of creating the invoice, a unique transaction identifier is also created that is associated with the invoice. The transaction identifier could be, for example, a randomly generated number that is associated with the invoice, or it could be an invoice number assigned to the invoice. Also in step 100, a tag 16 is created that includes the unique transaction identifier associated with the invoice prepared for consumer 30. Tag 16 may be, for example, a barcode, RF ID tag, alpha-numeric character string or the like. In step 105, the tag 16 is provided to the consumer 30 via a mail piece 14. If desired, the invoice may be embodied in a physical paper bill and placed in mail piece 14. Alternatively, if consumer 30 does not wish to receive a paper bill, mail piece 14 may be a simple post card. Tag 16 can be printed on the mail piece 14, printed on a label attached to mail piece 14, or secured to mail piece 14 in any suitable manner, and sent to the consumer. Alternatively, the tag 16 may be a unique link residing in an e-mail that is sent to the consumer as further described below.

Also in step 105, customer specific data 34, including data from the invoice created by biller 12a for consumer 30, is saved in a standard format and electronically sent to an intermediary secure server 20 along with tag 16. The customer specific data 34 includes a user identification 42 (further described below). Preferably, the data is formatted as Extensible Markup Language (XML). Alternatively, data related to consumer 30 can be sent to the intermediary secure server 20, along with tag 16, and the secure server 20 will extract the desired data. This can occur, for example, when the biller 12a sends the actual print stream data intended to be printed on the biller's printer to secure server 20. The customer specific data 34, along with the invoice data, can also include additional information relating to the charges and expenses for consumer 30, such as, for example, charts or tables breaking down the expenses by categories, location, etc. Additionally, the customer specific data 34 can include, for example, targeted advertising for products or services that consumer 30 may be interested in based on previous purchases or spending habits. Since the storage of this information is electronic, it can include multimedia rich data such as, for example, video, audio, or other actively rendered content that could not be readily rendered on a paper invoice. Optionally, server 20 can archive the customer specific data 34, 35, 36, or portions thereof, from billers 12a, 12b, 12c, respectively.

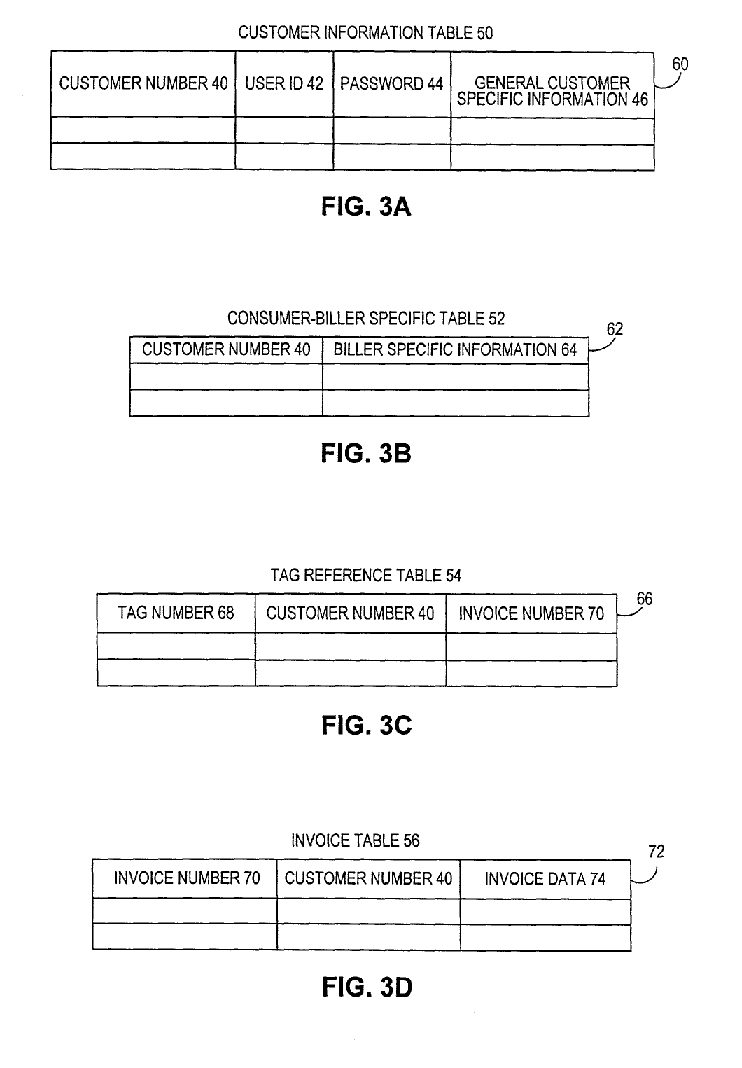

Server 20 includes a relational database 38 comprising a plurality of tables in which customer information is maintained. For example, FIGS. 3A-3D each illustrate a table included in data base 38. Specifically, FIG. 3A illustrates a Customer Information Table 50, FIG. 3B illustrates a Consumer-Biller Specific Table 52, FIG. 3C illustrates a Tag Reference Table 54, and FIG. 3D illustrates an Invoice Table 56.

Customer Information Table 50 includes a plurality of customer records 60. Each customer record 60 includes a customer number 40, a user identification number 42, a user password 44, and general customer specific information 46. Consumer-Biller Specific Table 52 includes a plurality of consumer-biller records 62, each of which includes a customer number 40 and biller specific information 64. Thus, there may be a plurality of consumer-biller records 62 for each consumer, one for each biller with which the consumer has a relationship. Tag Reference Table 54 includes a plurality of tag records 66. Each tag record 66 includes a tag number 68, i.e., the unique transaction identifier that was created when an invoice is prepared, customer number 40 and an invoice number 70. Invoice Table 56 includes a plurality of invoice records 72. Each invoice record 72 includes an invoice number 70, a customer number 40, and invoice data 74 associated with the invoice number 72. Thus, there may be a plurality of invoice records 72 for consumer 30, one for each invoice sent by each biller 12a, 12b, 12c.

The operation of database 38 is as follows. As information arrives at server 20 from biller 12a relating to consumer 30, it is determined if a customer record 60 for consumer 30 is present in Customer Information Table 50. This customer record 60 for consumer 30 may have been previously created, for example, by consumer 30 enrolling with the system 10, or by a biller enrolling consumer 30 with system 10. Establishing this customer record 60 for consumer 30 includes creating a unique customer number 40 for consumer 30. If a customer record 60 for consumer 30 does not exist, a record 60 is created and entered into table 50.

Next, it is determined if biller 12a is a new biller for consumer 30. If biller 12a is a new biller for consumer 30, a consumer-biller record 62 is created that associates the customer number 40 assigned to consumer 30 with biller specific information 64 for biller 12a. If biller 12a is not a new biller for consumer 30, and a consumer-biller record 62 already exists, it is determined if any information related to the relationship between biller 12a and consumer 30 has changed, and if so, the consumer-biller record 62 for consumer 30 and biller 12a will be updated.

Next, a tag record 66 is created that includes the tag number 68 for the invoice created by biller 12a for consumer 30, the customer number 40 for consumer 30, and an invoice number 70 for the invoice created for consumer 30 by biller 12a. Tag record 66 is linked to consumer's 30 customer record 60 by the customer number 40. Once the tag record 66 has been established, an invoice record 72 is created in the Invoice Table 56. Invoice record 72 includes the invoice number 70, the customer number 40 for consumer 30, and invoice data 74, which includes the customer specific data 34 sent from biller 12a. Thus, the invoice record 72 for the invoice created for consumer 30 by biller 12a is linked to the corresponding tag record 66 by the invoice number 70 and to the customer record 60 for consumer 30 by customer number 40.

It should be noted, of course, that the present invention is not limited to the architecture and linking between the tables 50, 52, 54, 56 of database 38 as described with respect to FIGS. 3A-3D, and that any number of tables having any type of arrangement and linking may also be utilized.

Referring again to FIG. 2, the consumer 30, upon receiving the mail piece 14, inputs the data included in tag 16 into computer 32 in step 110. Inputting can be performed manually (if the tag 16 is a character string) or inputting can be done by scanning the tag 16 with a camera, barcode reader, scanner or any other suitable device. Such scanning can be performed by a peripheral device (not shown) coupled to computer 32, such as, for example, a barcode reader, scanner or camera, in conjunction with associated software operating on computer 32. Alternatively, to reduce the need for any software associated with a peripheral device to be resident on computer 32, inputting of tag 16 could also be performed utilizing a Web based browser operating on computer 32. Additionally, if the consumer 30 is a business that has incoming mail handling procedures, scanning can be performed in an automated fashion during the handling procedures. Alternatively, tag 16 can be sent electronically, such as, for example, by e-mail, directly to the computer 32 of consumer 30. Since tag 16 contains only a randomly generated number or invoice number, i.e., the unique transaction identifier, for consumer 30 and does not contain any type of sensitive information, such as, for example, account numbers, credit card numbers or the like, the e-mail from biller 12a to the consumer 30 containing tag 16 need not be secure. The consumer 30 initiates a communication with server 20, utilizing Internet technology and the WWW via computer 32, and transmits the data from tag 16 to server 20 in step 115. If the tag 16 is received via e-mail, the communication can be triggered by linking to a Uniform Resource Locator (URL) included in the e-mail.

Upon receiving the data from tag 16, in step 120 server 20 will determine if the consumer 30 is properly authenticated. If consumer 30 is not properly authenticated, then in step 125 server 20 will request authentication from consumer 30. Authentication can require, for example, requesting the consumer 30 to enter a user identification 42 as well as a user password 44. Failure to provide a correct user identification 42 or password 44 will prevent access to the database 38 maintained by server 20. Thus, even if the tag 16 is incorrectly delivered or intercepted and sent to server 20 by a non-intended recipient, access to any information included in the database 38 of server 20 is still prevented. It should be understood that authentication need not be limited to a user identification 42 and password 44 as described above. Authentication can be performed by any method utilizing any type of data, including biometric data or other data. Additionally, authentication could occur upon initiation of the communication between consumer 30 and server 20.

Server 20, after receiving the unique transaction identifier data, i.e., tag number 68, from tag 16 and determining proper authentication of the consumer 30, will in step 130 search the Tag Reference Table 54 of database 38 for the tag number 68 included in tag 16. In step 135 it is determined if the tag number 68 from tag 16 is found in table 54. If tag number 68 from tag 16 is not found in Tag Reference Table 54, then in step 140 consumer 30 will be denied any further access to database 38. If tag number 68 included in tag 16 is found in Tag Reference Table 54, the system 10 utilizes the customer number 40 in tag record 66 to identify the linked customer record 60 in Customer Information Table 50. In step 145, it is determined if the user identification, input by the consumer 30 during authentication (step 120), corresponds with the user identification 42 included in the identified linked customer record 60. If the user identification 42 of customer record 60 does not correspond to the user identification input by the consumer 30 during authentication, then in step 140 consumer 30 will be denied further access to database 38. Thus, even if tag number 68 from tag 16 is found but the user identification number 42 of customer record 60 does not match the user identification number input by the user, the user will be denied access to any information associated with the tag 16, i.e., invoice data for consumer 30 from biller 12a. This feature adds an additional level of security to system 10, thereby preventing parties that do gain access to server 20 from obtaining information not intended specifically for them. If it is determined that the user identification 42 does correspond in step 145, then in step 150 the invoice number 70 associated with the tag number 68 is utilized to determine the associated invoice data 74 from invoice record 72 and the invoice data 74 is sent from server 20 to consumer computer 32. Optionally, server 20 could also provide an indication to biller 12a that invoice data 74 has been accessed by consumer 30, thereby allowing biller 12a to further track payment history and anticipate payment by consumer 30.

Upon receipt of the invoice data 74 from server 20, computer 32 is configured with templates that will extract data from the invoice data 74 and insert the data into the appropriate fields of the specified software systems used by consumer 30 in step 155. Such insertion could be performed, for example, utilizing an application programming interface (API), a configurable mapping technique, predetermined fields, or programmatic keyboard insertion. Thus, according to the present invention, fields in both accounting and payment software systems will be automatically populated with the correct data directly from the invoice data 74, thereby significantly reducing the amount of time necessary for entry of the invoice data while ensuring accurate entry of the data. Additionally, if a template does not exist for data entry into an accounting or payment software system being run on computer 32, computer 32 is configured to operate in a training mode to create a template. For example, during training mode, computer 32 will instruct consumer 30 to indicate the fields, such as, for example, utilizing the keyboard of computer 32, of the new accounting or payment software system into which specific pieces of data from the invoice data 74 should be entered. Computer 32 will then create a template for that new accounting or payment software system, thereby allowing the system 10 to be used with any type of accounting or payment software.

In addition to automatically populating the fields of specified accounting and payment software systems of computer 32, system 10 according to the present invention provides additional value-added benefits to both consumer 30 and biller 12a. Many billers consider their monthly bill to consumers as an “appointment” with the consumer during which the biller can identify new products or services to the consumer, indicate ways the consumer can save money each month, build customer loyalty, and the like. Thus, when consumer 30 logs into server 20 and accesses the invoice data 74, the additional information included in invoice data 74, such as, for example, the customer specific data 34 relating to the charges and expenses or targeted advertising, can be presented to consumer 30 in step 160. Such presentation could occur, for example, utilizing pop-up boxes, video downloads, or other multi-media presentations. Accordingly, information or advertising presented to consumer 30 is controlled by the billers, thereby allowing each biller to maintain a relationship with the consumer 30. Thus, server 20 of system 10 according to the present invention remains relatively transparent to consumer 30. Additionally, the billers can reduce their mailing costs for bills as such advertising and marketing can now be accomplished electronically, thereby removing the need to include inserts with the monthly bills to consumers. Furthermore, the use of system 10 according to the present invention to provide additional information to consumers, such as, for example, targeted advertising, via the consumer's computer when providing invoice information, allows billers to provide a multi-media experience to consumers. Such multi-media experiences can enhance the consumer's perception of the biller, leading to increased consumer satisfaction, loyalty and more business with the biller.

Thus, according to the present invention, a billing party generates a unique transaction identification in the process of preparing an invoice and sends the transaction identification to the consumer via an envelope, postcard or e-mail. The invoice data, along with other customer specific data, is stored in a standard format in a secure server in a location pointed to in part by the transaction identification. The consumer, upon receipt of the envelope or postcard, inputs the transaction identification into a computer and sends it to the server. The server retrieves the invoice data and sends it to the consumer, and the invoice data is automatically entered into the consumer's accounting and/or payment software systems.

While the system 10 has been described with respect to invoicing, the invention is not so limited and is also applicable to other scenarios, such as, for example, order-entry for procurement activities. For example, specifications and costs for a particular order can be compiled by a seller and stored in server 20. This information can then be accessed and entered into the software systems of the purchaser to allow authorizations to occur and for the purchasing department of the purchaser to issue a purchase order. By utilizing the system 10 according to the present invention, entry of the specifications and costs are done easily and accurately into the purchaser's software systems.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for importing data generated by a vendor into a software program comprising the steps of:
generating, at said vendor, said data, said data being specific to a consumer;
generating, at said vendor, a transaction identification number associated with said data;
creating a tag, said tag including said transaction identification number;
sending said tag to said consumer;
sending said data and said transaction identification number to a server remote from said vendor;
storing said data and said transaction identification number at said server;
said consumer, in response to receiving said tag, sending said tag to said server utilizing a computer;
said server, in response to receiving said tag from said consumer, sending at least a portion of said data associated with said transaction identification number to said computer; and
said computer, in response to receiving said at least a portion of said data associated with said transaction identification number, automatically importing said at least a portion of said data into at least one software program resident on said computer.

2. The method according to claim 1, wherein said step of generating said data further comprises:
generating invoice data specific to said consumer.

3. The method according to claim 2, wherein said data further includes advertising targeted specifically to said consumer.

4. The method according to claim 3, further comprising:
displaying said advertising to said consumer on a display of said computer.

5. The method according to claim 2, wherein said transaction identification number is an invoice number.

6. The method according to claim 1, wherein said transaction identification number is a randomly generated number.

7. The method according to claim 1, wherein said step of creating a tag further comprises:
creating a bar code tag.

8. The method according to claim 1, wherein said step of creating a tag further comprises:
creating a character string tag.

9. The method according to claim 1, wherein said step of creating a tag further comprises:
creating an RF ID tag.

10. The method according to claim 1, wherein said step of sending said tag further comprises:
sending said tag with a mail piece to said consumer.

11. The method according to claim 10, further comprising:
printing said tag on a face of said mail piece.

12. The method according to claim 1, wherein said step of sending said tag further comprises:
sending said tag via e-mail to said consumer.

13. The method according to claim 1, wherein said step of said consumer sending said tag to said server further comprises:
scanning said tag into said computer.

14. The method according to claim 1, wherein said step of said consumer sending said tag to said server further comprises:
sending said tag to said server utilizing a Web browser.

15. The method according to claim 1, wherein said step of sending at least a portion of said data associated with said transaction identification number to said computer further comprises:
determining if said consumer is properly authenticated to access said server; and
if said consumer is properly authenticated, searching a database for said transaction identification number.

16. The method according to claim 15, wherein if said transaction identification number is found said method further comprises:
determining if said transaction identification number is associated with a user identification input by said consumer;
if said transaction identification number is associated with said user identification input by said consumer, sending said at least a portion of said data associated with said transaction identification number to said computer; and
if said transaction identification number is not associated with said user identification input by said consumer, denying access to said data.

17. The method according to claim 1, wherein said data includes an order entry.

18. The method according to claim 1, further comprising:
archiving said data generated by said vendor at said server.

19. A method for automatically importing invoice data from a biller into a software program utilized by a consumer comprising the steps of:
generating, at said biller, said invoice data and an associated transaction identification number;
sending said transaction identification number to said consumer;
storing said invoice data and said transaction identification number in a server remote from said biller;
sending said transaction identification number from said consumer to said server;
retrieving said invoice data from said server in response to receiving said transaction identification number from said consumer;
sending said retrieved invoice data from said server to said consumer; and
populating at least one field of a software program being operated by said consumer with a portion of said retrieved data.

20. The method according to claim 19, wherein said step of sending said transaction identification number to said consumer further comprises:
sending said transaction identification number with a mail piece to said consumer.

21. The method according to claim 20, further comprising:
printing said transaction identification number on a face of said mail piece.

22. The method according to claim 19, wherein said step of sending said transaction identification number to said consumer further comprises:
sending said transaction identification number via e-mail to said consumer.

23. The method according to claim 19, wherein said step of retrieving said invoice data further comprises:
determining if said consumer is properly authenticated to access said server; and
if said consumer is properly authenticated, searching a database for said transaction identification number.

24. The method according to claim 23, wherein if said transaction identification number is found said method further comprises:
determining if said transaction identification number is associated with a user identification input by said consumer; and
if said transaction identification number is associated with said user identification input by said consumer, sending said retrieved invoice data from said server to said consumer.

25. The method according to claim 19, further comprising:
archiving said invoice data at said server.

26. A system for retrieving data comprising:
at least one vendor, said at least one vendor generating said data, said data being specific to a consumer, said at least one vendor further generating a tag associated with said data, said vendor sending said tag to said consumer;
a server remote from said vendor, said server receiving said data and said tag from said vendor and storing said data and said tag; and
a computer operable by said consumer and coupled to said server via a network, said computer having a plurality of software programs to control operation thereof,
wherein said consumer inputs said tag into said computer, sends said tag to said server via said network and said server provides said data to said computer via said network, said computer in response to receiving said data automatically populating fields of at least one of said plurality of software programs with at least a portion of said data received from said server.

27. The system according to claim 26, wherein said tag is sent to said consumer by electronic mail.

28. The system according to claim 26, wherein said tag is sent to said consumer with a mail piece.

29. The system according to claim 28, wherein said tag is printed on a face of said mail piece.

30. The system according to claim 26, wherein said tag includes a barcode.

31. The system according to claim 26, wherein said tag includes a character string.

32. The system according to claim 26, wherein said tag is an RF ID tag.

33. The system according to claim 26, wherein said data includes an order entry.

34. The system according to claim 26, wherein said data includes an invoice.

35. The system according to claim 34, wherein said data further includes information relating to spending habits of said consumer.

36. The system according to claim 34, wherein said data further includes advertising targeted specifically for said consumer.

37. The system according to claim 36, wherein said computer is further adapted to display on a display to said consumer said advertising targeted specifically for said consumer.

38. The system according to claim 26, further comprising:
a scanner coupled to said computer, wherein said consumer inputs said tag to said computer using said scanner.

39. The system according to claim 26, wherein said at least one of said plurality of software programs includes a finance management program.

40. A system for automatically importing invoice data for a consumer into a software program comprising:
a biller, said biller generating said invoice data for said consumer and a transaction identification number associated with said invoice data, said biller sending said transaction identification number to said consumer;
a server, remote from said biller, to store said invoice data for said consumer and said transaction identification number; and
a computer operable by said consumer and coupled to said server via a network, said software program being resident on said computer,
wherein said consumer inputs said transaction identification number to said computer and sends said transaction identification number to said server, said server in response to receiving said transaction identification number provides said invoice data to said computer, and said computer in response to receiving said invoice data automatically imports said invoice data into said software program.

41. The system according to claim 40, wherein said transaction identification number is sent to said consumer by electronic mail.

42. The system according to claim 40, wherein said transaction identification number is sent to said consumer with a mail piece.

43. The system according to claim 42, wherein said transaction identification number is printed on a face of said mail piece.

44. The system according to claim 40, wherein said server archives said invoice data for said consumer.
